(19) United States
(12) Patent Application Publication
(10) Pub. No.: US 2018/0186113 A1
(43) Pub. Date: Jul. 5, 2018

(54) USER-DEFINED BOX CREATION APPARATUS

(71) Applicant: Fiskars Brands, Inc., Middleton, WI (US)

(72) Inventors: Daniel Cunningham, Edgerton, WI (US); Douglas Nelson, Madison, WI (US)

(73) Assignee: Fiskars Brands, Inc., Middleton, WI (US)

(21) Appl. No.: 15/397,345

(22) Filed: Jan. 3, 2017

(51) Int. Cl. B31B 50/44; B31B 50/22; B31B 50/59; B31B 50/99; B31B 50/56

(52) U.S. Cl. CPC B31B 50/44; B31B 50/22; B31B 2247/00; B31B 50/99; B31B 50/56; B31B 50/59

(57) ABSTRACT

One embodiment relates to an apparatus configured to create a box having a width and a height. The apparatus comprises a first control slider movably connected to a body. The first control slider is structured to move to a width position that alters the box width. A second control slider movably connected to the body. The second control slider is structured to move to a height position that alters the box height. A third control slider movably connected to the body, the first control slider, and the second control slider. The third control slider is responsive to the width position of the first control slider and the height position of the second control slider. A size value guide movably connected to the third control slider and is responsive to movement of the third control slider. The size value guide indicates a paper needed to create the user desired box.

### TECHNICAL FIELD

The present application relates generally to the field of cutting devices for cutting a user-defined box or envelope (herein collectively referred to as “box”).

### BACKGROUND

Cutting devices may be used to cut a desired sized box in sheet material. However, it may be difficult to consistently cut the desired box shape with scissors or another similar hand-held tool. Specifically tailored tools allow a user to create a box (e.g., gift box, storage box, gift envelope, gift storage, etc.) out of a single sheet material. However, these tools require the user to choose the final box-size from a pre-set list, limiting the variety of boxes generated. Additionally, the resulting dimensions of the box generated from these tools often differ from the pre-set listed dimensions.

### SUMMARY

One embodiment relates to an apparatus configured to create a box, the box having a box width and a box height. The apparatus comprises a first control slider movably connected to a body. The first control slider is structured to move to a width position, the width position altering the box width. A second control slider movably connected to the body. The second control slider is structured to move to a height position, the height position altering the box height. A third control slider movably connected to the body, the first control slider, and the second control slider. The third control slider is responsive to the width position of the first control slider and the height position of the second control slider. A size value guide movably connected to the third control slider. The size value guide is responsive to movement of the third control slider. The size value guide indicates a paper needed to create the box with the box width and box height.

Another embodiment relates to a method for generating a box with a box height and a box width. The method comprises adjusting a first control slider. The first control slider movably connected to a body. The first control slider structured to move to a width position, the width position altering the box width. A second control slider is adjusted. The second control slider movably connected to a body. The second control slider is structured to move to a height position, the height position altering the box height. A size value is identified. The size value is movably connected to a third control slider. The third control slider is responsive to the width position of the first control slider and the height position of the second control slider. The size value identifies a paper needed to create the box with the box width and box height.

Yet another embodiment relates to an apparatus configured to create a box, the box having a box width and a box height. The apparatus comprises a first control slider movably connected to a body. The first control slider is structured to move to a width position, the width position altering the box width. A second control slider movably connected to the body. The second control slider is structured to move to a height position, the height position altering the box height. A third control slider movably connected to the body, the first control slider, and the second control slider. The third control slider is responsive to the width position of the first control slider and the height position of the second control slider. A size value guide movably connected to the third control slider. The size value guide is responsive to movement of the third control slider. The size value guide indicates a paper needed to create the box with the box width and box height. A punch is connected to the body. The punch comprises a vertical guide and a horizontal guide for scoring the paper. The punch is structured to create a plurality of notches on each side and corner of the paper. A first paper stop is connected to the first control slider. The first paper stop provides guidance in scoring the paper. A second paper stop is connected to the second control slider. The second paper stop provides guidance in scoring the paper.

The foregoing is a summary and thus by necessity contains simplifications, generalizations, and omissions of detail. Consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a top perspective view of an apparatus for creating a user-defined box, in accordance with an exemplary embodiment.

FIG. 2 is an exploded view of the apparatus for creating a user-defined box shown in FIG. 1.

FIG. 3 is a top plan transparent view of the apparatus for creating a user-defined box shown in FIG. 1.

FIG. 4A is a top plan transparent view of the apparatus for creating a user-defined box shown in FIG. 3 in a first box height position.

FIG. 4B is a top plan transparent view of the apparatus for creating a user-defined box shown in FIG. 4A in a second box height position.

FIG. 5A is a top plan transparent view of the apparatus for creating a user-defined box shown in FIG. 3 in a first box width position.

FIG. 5B is a top plan transparent view of the apparatus for creating a user-defined box shown in FIG. 5A in a second box width position.

FIG. 6 is a method flow diagram of using the apparatus for creating a user-defined box shown in FIG. 1.

### DETAILED DESCRIPTION

Referring to the figures generally, an apparatus for creating a user-defined box is provided. The user-defined box creation apparatus addresses limitations in the art by allowing a user to create a box by independently defining the desired resulting box's base size and height. The user-defined box creation apparatus provides mechanisms to simply communicate the size of the box desired by the user and the size of the paper required to create the desired box. The customization of the user-defined box creation apparatus allows a user to customize the desired box to precisely fit an included object (e.g., a gift). As will be appreciated, the user-defined box creation apparatus makes use of a series of mechanisms that are driven by the user's interaction with sizing sliders on the apparatus. The mechanisms make use of a compound sliding mechanism mechanically calculate the required paper size and to display the required paper sheet size on a slider visible in the center of the apparatus. The tool itself mechanically calculates the required paper size using a compound sliding mechanism.

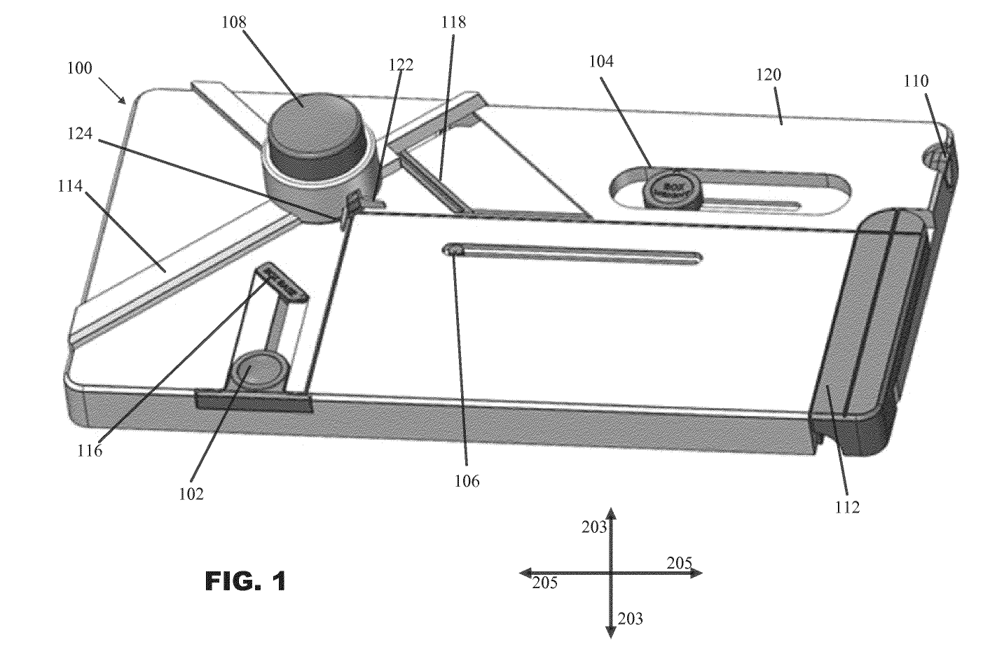

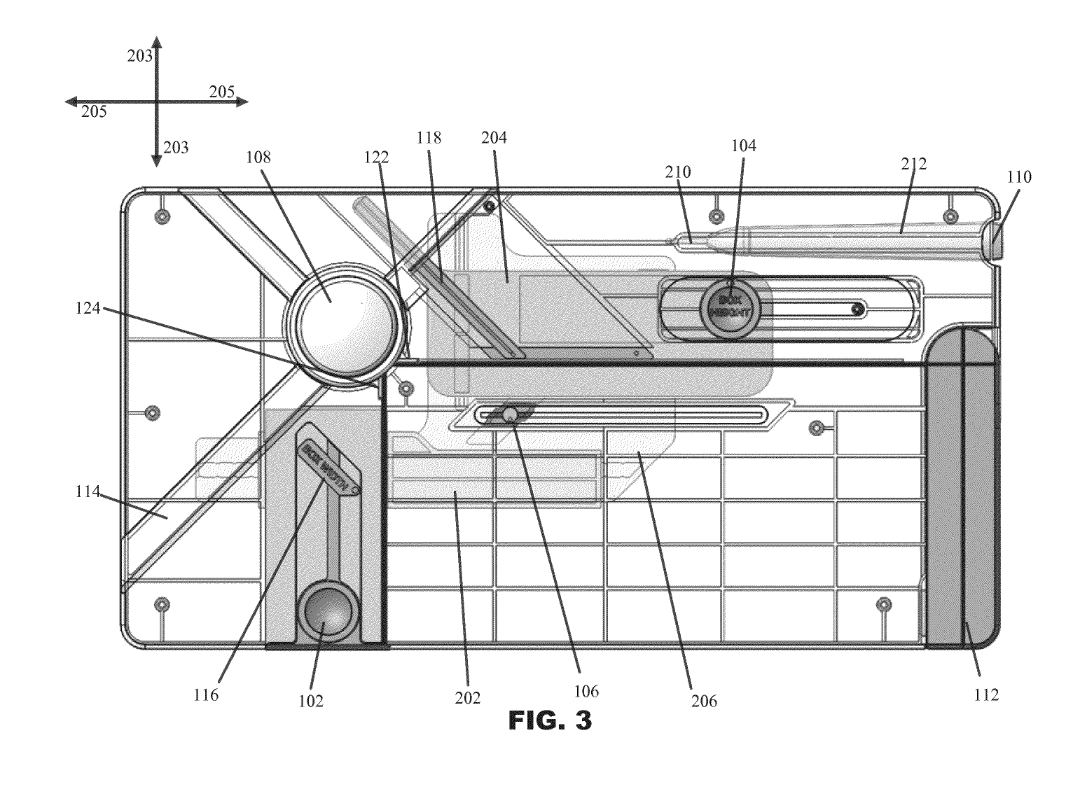

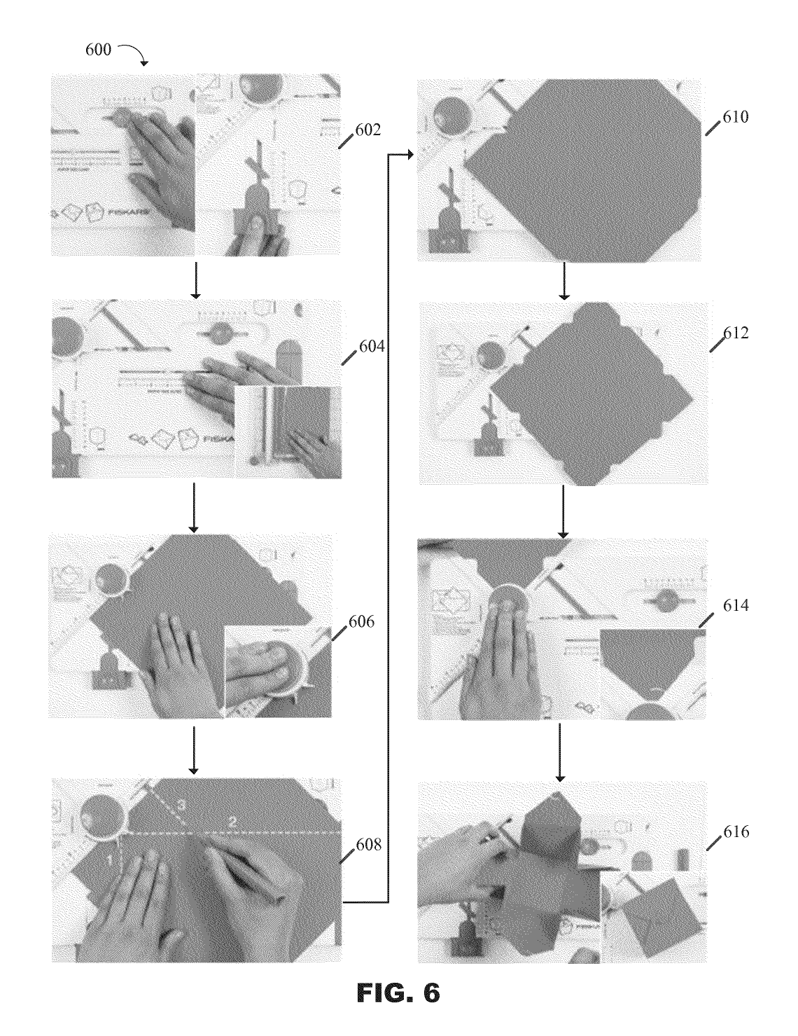

Referring to FIG. 1, a top perspective view of an apparatus 100 for creating a user-defined box is illustrated, in accordance with an exemplary embodiment. The user-defined box creation apparatus 100 includes a box width slider 102, a box height slider 104, a paper size guide 106, a punch 108, a scoring stylus 110, an arm extension 112, a raised ruler 114, a box width stop 116, a diagonal score guide 118, and an body 120. As will be appreciated, by the user sliding the box height slider 104 and the box width slider 102, the paper size guide 106 will automatically adjust to display the paper size needed to generate a box with the user desired height and width. Accordingly, the box width stop 116 and the diagonal score guide 118 will automatically move into the appropriate position to receive the required paper size and properly score (e.g., to create a line or depression in the paper that will help the paper fold) the paper to generate the box. The automatic movement of the paper size guide 106, the box width stop 116, and the diagonal score guide 118 is facilitated by a plurality of sliding mechanisms located inside the body 120. The interactions of the plurality of sliding mechanisms located inside the body 120 is explained in greater detail below with respect to FIGS. 3, 4A, 4B, 5A, and 5B. A method 600 for using the user-defined box creation apparatus 100 to generate a box is explained in greater detail below in FIG. 6.

The box width slider 102 and the box height slider 104 are adjustable by the user to alter the desired box dimensions. The box width slider 102 and the box height slider 104 are communicably coupled to the paper size guide 106 via mechanisms inside the body 120 that are hidden from the user's view. Movement of one or both of the box width slider 102 and the box height slider 104 will alter the paper size indicated on the paper size guide 106. The box width slider 102 and the box height slider 104 allow the user to adjust the sliders to any position within the range of the respective slider's track. As will be appreciated, the range of possible box dimensions may be limited to the available size of single sheet paper or the size of the user-defined box creation apparatus 100. In some embodiments, the box width slider 102 and/or the box height slider 104 may have printed desired dimension increments on the body 120 to guide the user in adjusting the sliders 102, 104. For example, the printed dimensions could be from a range of 0.25 inches to 20 inches, with tic marks at every 0.25 inch. The sliders 102, 104 are such that the user is able to “select” any size within the dimensions possible by the user-defined box creation apparatus 100 merely by sliding the slider to the desired location on the sliding track.

The paper size guide 106 is communicably coupled to the box width slider 102 and the box height slider 104, such that movement of either or both sliders will alter the required paper size indicated by the paper size guide 106. In some embodiments, the paper size guide 106 may have two indicators, one for a paper width and one for a paper length. In other embodiments, the paper size guide 106 only has one indicator, either of a required paper width or a paper length needed to generate the box, with an assumption that the paper being used is a standard paper, for example an 8.5 by 11 inch (e.g., 215.9 mm by 279.4 mm) paper.

The punch 108 includes a horizontal scoring guide 122 and a vertical scoring guide 124 attached to the punch housing. The punch 108 is structured to generate notches in the sides and corners of the paper to facilitate the folding of the paper into the box. When a paper is flush with both the punch 108 and the raised ruler 114, the horizontal scoring guide 122, the vertical scoring guide 124, and the diagonal score guide 118 are used to score each side of the paper and generate scored lines that can be folded into the user-defined box.

The scoring stylus 110 is removably coupled to the body 120. The scoring stylus 110 is used on the horizontal scoring guide 122, the vertical scoring guide 124, and the diagonal score guide 118 to score the three lines on each side of the paper. In some embodiments, the user-defined box creation apparatus 100 does not include the scoring stylus 110, instead allowing the user to provide a separate scoring stylus or mechanism.

The arm extension 112 is movably attached to the side of the body 120. The arm extension 112 provides a longer horizontal scoring guide for larger paper sizes. If the user desires, the arm extension 112 may be engaged into a second position that is longer along the horizontal axis formed by the horizontal scoring guide 122. When engaged, the arm extension 112 allows the user to score, along the horizontal scoring guide, a larger paper.

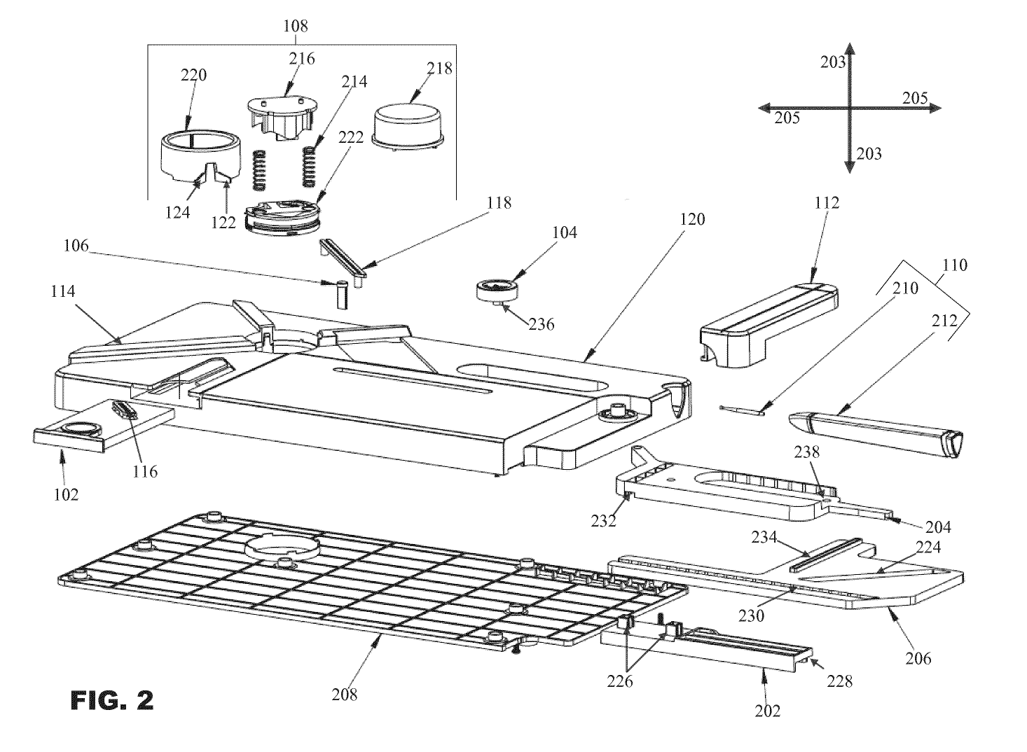

Referring to FIG. 2, an exploded view of the apparatus for creating a user-defined box shown in FIG. 1 is illustrated. The user-defined box creation apparatus 100 includes the box width slider 102, the box height slider 104, the paper size guide 106, the punch 108, the scoring stylus 110, an arm extension 112, the raised ruler 114, the box width stop 116, the diagonal score guide 118, the body 120, and a body base 208, a first slider 202, a second slider 204, and a third slider 206.

The first slider 202, the second slider 204 and the third slider 206 are stored within the body 120 and the body base 208, and are hidden from view of the user. The first slider 202 is communicably coupled through a first interlocking slide track to the third slider 206 and via a snap fit connection to the box width slider 102. The first interlocking slide track includes a male slide end 228 on the first slider 202 that fits into a female slide end 230 on the third slider 206. The snap fit connection includes a male end 226 on the first slider 202 that attaches to a female end (not shown) beneath the box width slider 102. The second slider 204 is communicably coupled through a second interlocking slide track to third slider 206 and through a snap fit to the box height slider 104. The second interlocking slide track includes a female slide end 232 on the second slider 204 that fits over a male slide end 234 on the third slider 206. The snap fit includes a male end 236 on the box height slider 104 that attaches to a female end on the second slider 204. The third slider 206 is communicably coupled through the first interlocking slide track to the first slider 202, through the second interlocking slide track to the second slider 204, and though a third interlocking slide track to the paper size guide 106. The third interlocking slide track includes a female end diagonal track 224 within the body of the third slider 206 that receives the male end of the paper size guide 106. In some embodiments, one or more of the snap fit couplings may be integrally formed or machined into a single piece during assembly.

Generally, movement of the box width slider 102 by the user will cause the first slider 202 to move and, in turn, the third slider 206. Movement of the box height slider 104 by the user will cause the second slider 204 to move and, in turn, the third slider 206. Movement of the third slider 206 (as a result of direct user-interaction of one or both of the box height slider 104 and the box width slider 102) will cause the paper size guide 106 to adjust. The first slider 202 is configured to move in latitudinal direction (along axis 203), the second slider 204 is configured to move in the longitudinal direction (along axis 205), and the third slider 206 is bidirectional, configured to move in both the longitudinal and latitudinal directions.

Expanding on the interactions, the translation of the box width slider 102 by the user in the latitudinal direction along the slide track results in the translation of the first slider 202 in the same direction. Since the first slider 202 is communicably coupled to the third slider 206, the latitudinal translation of the first slider 202 results in a latitudinal translation of the third slider 206. Specifically, the latitudinal translation of the first slider 202 results in the male slide end 228 pulling the third slider 206 latitudinally via the female slide end 230. While the third slider 206 is communicably coupled to the second slider 204, the latitudinal translation of the first slider 202 or third slider 206 does not result in movement by the second slider 204. This is a result of the second interlocking slide track, as the male slide end 234 moves latitudinally through the female slide end 232 without moving the second slider 204.

The translation of the box height slider 104 by the user in the longitudinal direction along the slide track results in the translation of the second slider 204 in the same direction. Since the second slider 204 is communicably coupled to the third slider 206, the longitudinal translation of the second slider 204 results in a longitudinal translation of the third slider 206. Specifically, the longitudinal translation of the second slider 204 results in the female slide end 232 pulling the third slider 206 longitudinally via the male slide end 234. While the third slider 206 is communicably coupled to the first slider 202, the longitudinal translation of the second slider 204 or third slider 206 does not result in movement by the first slider 202. This is a result of the first interlocking slide track, as the female slide end 230 moves longitudinally below the male slide end 228 without moving the first slider 202.

The translation of the box height slider 104 by the user in the longitudinal direction or translation of the box width slider 102 by the user in the latitudinal direction results in the longitudinal movement of the paper size guide 106. While the movement of the paper size guide 106 is longitudinal along the track, the paper size guide 106 is communicably connected to a diagonal track 224 within the third slider 206. The diagonal track 224 is orientated such that a longitudinal translation—in response to the second slider 204 movement—or a latitudinal translation—in response to the first slider movement 202—of the third slider 206 results in the translation of the paper size guide 106. As will be appreciated, the movement of the paper size guide 106—in response to movement of the box width slider 102 or box height slider 104—and the orientation of the diagonal track 224 results in a paper size being displayed that is required to generate the box having the dimensions selected by the user.

The punch 108 includes a punch blade 216, a button 218, a punch housing 220, springs 214, and a punch die 222. The punch blade 216 and punch die 222 are structured to cut the paper and generate the proper sized notches for facilitating the folding of the user-defined box. The punch button 218 provides a user-friendly mechanism for engaging the punch 108. The springs 214 ensure the punch 108 returns to an open position after engagement with the paper. The punch housing 220 includes the horizontal scoring guide 122 and the vertical scoring guide 124. In some embodiments, the horizontal scoring guide 122 and the vertical scoring guide 124 may be separate from the punch housing 220.

The scoring stylus 110 includes a scoring blade 210 and a scoring handle 212. The scoring blade 210 is structured to create a line or depression in the paper that will help the paper fold (e.g., score the paper, scoring, etc.). The scoring handle 212 facilitates user-friendly, ergonomic usage of the scoring blade 210.

Referring to FIG. 3, a top plan transparent view of the apparatus for creating a user-defined box shown in FIG. 1 is illustrated. The user-defined box creation apparatus 100 includes the box width slider 102, the box height slider 104, the paper size guide 106, the punch 108, the scoring stylus 110, an arm extension 112, the raised ruler 114, the box width stop 116, the diagonal score guide 118, the body 120, and body base 208, a first slider 202, a second slider 204, and a third slider 206.

The first slider 202, the second slider 204, and the third slider 206 are structured to mechanically lock and interact with one another when the user slides either the box width slider 102 or the box height slider 104. The mechanical interactions are such that the movement of the box width slider 102 vertically, or the box height slider 104 horizontally, are driven at a 1-to-1 scale. However, the paper size guide 106 is not driven at a 1-to-1 scale; instead the paper size guide 106 is used to communicate to the user the correct size of paper that will create the box at the desired dimensions. The structure of the first slider 202, the second slider 204, and the third slider 206 are such that the paper size identified in the paper size guide 106 is governed by the following equation:

Paper Size=\sqrt{2}×(W_{box}+H_{box})+2×D_{punch}

where the W_{box} is the position of the box width slider 102, H_{box} is the position of the box height slider 104, and D_{punch} is the offset of the punch's 108 midpoint to the edge (e.g., the accommodation of the punch closure) of the punch. In some embodiments, the D_{punch} is 8.72 mm. In those embodiments, if the user desired a 3″×5″ box (76.2 mm×127 mm), the user would move the box height slider 104 to 5 inches and the box width slider 102 to 3 inches. The resulting paper size on the paper size guide 106 would be a 12″×12″ piece of paper, as \sqrt{2}×(76.2+127)+2×8.72=304.81 mm. Alternatively, if the user desired a 3″×4″ box (76.2 mm×101.6 mm), the user would move the box height slider 104 to 4 inches and the box width slider 102 to 3 inches. The resulting paper size on the paper size guide 106 would be a 10.59″×10.59″ piece of paper, as \sqrt{2}×(76.2+101.6)+2×8.72=268.9 mm. The user would trim their piece of paper, using the raised ruler 114 for guidance, to the indicated dimensions.

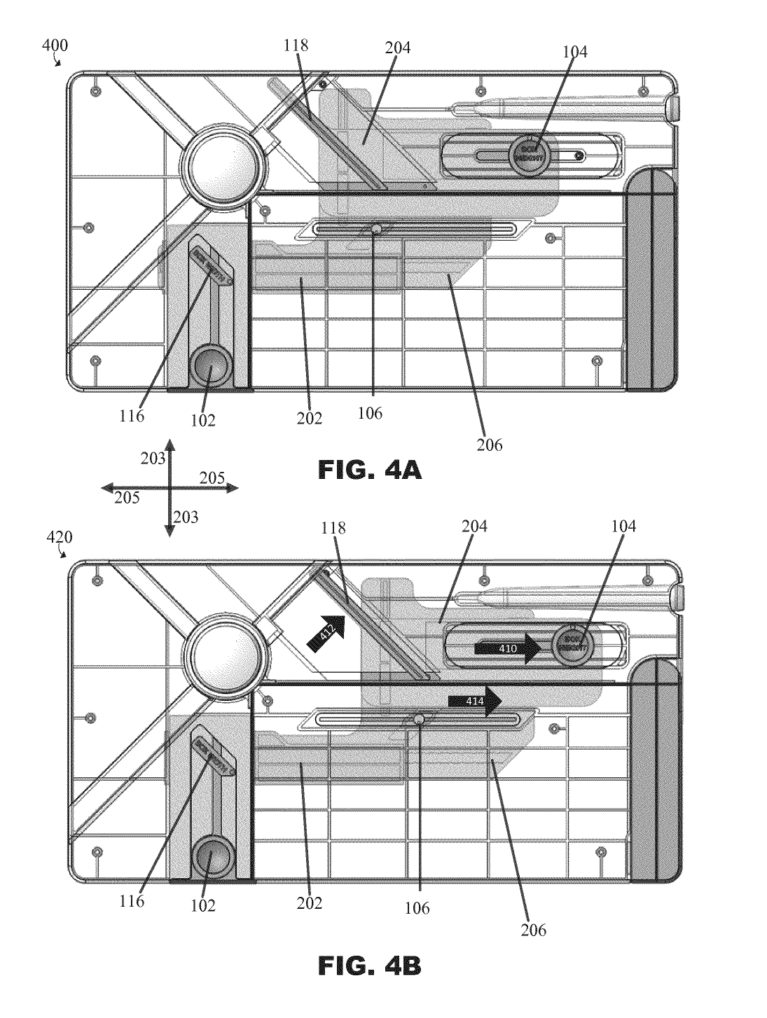

Referring to FIG. 4A, a top plan transparent view of the apparatus for creating a user-defined box shown in FIG. 3 in a first box height position 400 is illustrated. As shown in FIG. 4A, the box height slider 104 has been moved by the user to be positioned in the midway point of the slide track. Accordingly, the second slider 204, the third slider 206, and the paper size guide 106 have moved in response to the user movement of the box height slider 104.

Referring to FIG. 4B, a top plan transparent view of the apparatus for creating a user-defined box shown in FIG. 4A in a second box height position 420, is illustrated. In FIG. 4B, the user has adjusted 410 the box height slider 104 to a second position 420. This user-adjustment 410 of the box height slider 104 causes the horizontal movement 414 of the second slider 204, the third slider 206, and the paper size guide 106. The user-adjustment 410 of the box height slider 104 also causes the diagonal score guide 118 to move upward diagonally to accommodate the larger paper size needed for a box of the user-defined box height. As will be appreciated, the first slider 202 and the box width stop 116 remain unchanged in their respective positions as the user did not adjust the box width slider 102. Additionally, the third slider 206 remains unchanged in the vertical direction.

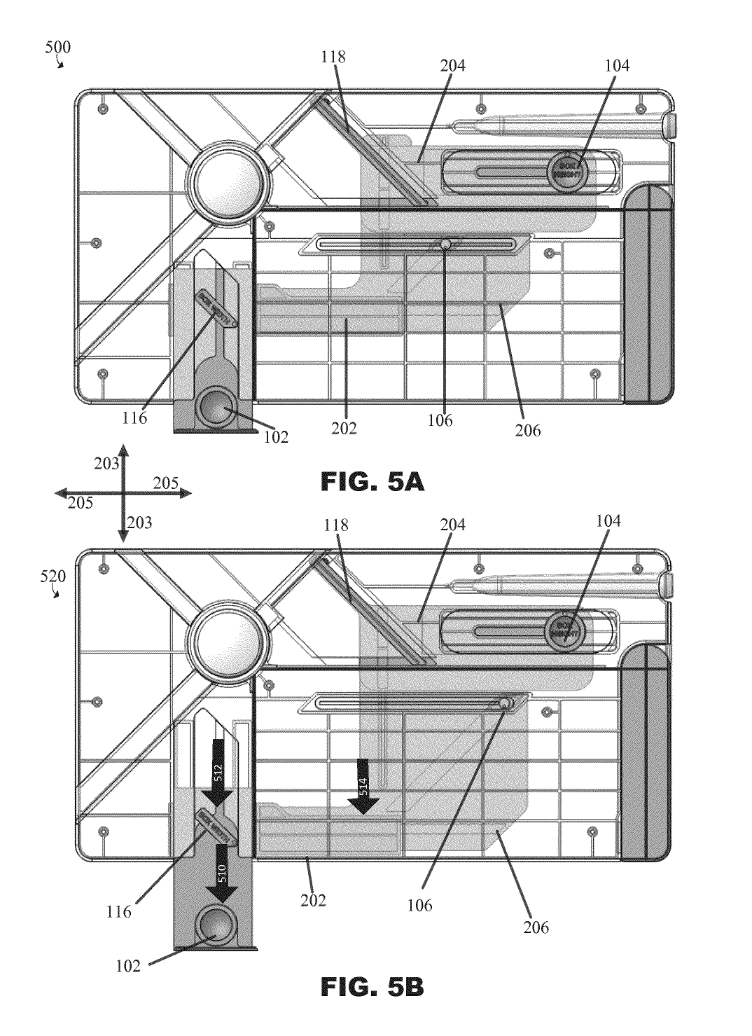

Referring to FIG. 5A, a top plan transparent view of the apparatus for creating a user-defined box shown in FIG. 3 in a first box width position 500 is illustrated. As shown in FIG. 5A, the box width slider 102 has been moved by the user to be positioned in the midway point of the slide track. Accordingly, the first slider 202, the third slider 206, and the paper size guide 106 have moved in response to the user movement of the box width slider 102.

Referring to FIG. 5B, a top plan transparent view of the apparatus for creating a user-defined box shown in FIG. 5A in a second box width position 520, is illustrated. The user has adjusted 510 the box width slider 102 to a second position 520. This user-adjustment 510 of the box width slider 102 causes the vertical movement 514 of the first slider 202, the third slider 206, and the paper size guide 106. The user-adjustment 510 of the box width slider 102 also causes the box width stop 116 to move downward vertically to accommodate the larger paper size needed for a box of the user-defined box width. As will be appreciated, the second slider 204 remains unchanged in position as the user did not adjust the box height slider 104. Additionally, the third slider 206 remains unchanged in the horizontal direction.

Referring to FIG. 6, a method 600 of using the apparatus for creating a user-defined box shown in FIG. 1 is illustrated. The method 600 begins at 602 with a user adjusting the box height slider 104 and the box width slider 102 to the desired box height and box base width, respectively. In some embodiments, the user-defined box creation apparatus 100 may have measurements printed next to the box height slider 104 and the box width slider 102 to provide guidance to the user while sliding the sliders 102, 104.

At 604, the user identifies the paper size indicated on the paper size guide 106 and generates a paper of those dimensions. In some embodiments, the user may use the raised ruler 114 on the user-defined box creation apparatus 100 to measure out and cut a paper that has greater dimensions than those indicated on the paper size guide 106. In some embodiments, the paper size guide 106 only contains adjustments to one dimension of a paper (e.g., width or length) in order to allow for at most one dimension to be altered. In some embodiments, the user generates the paper by manually cutting the paper to the indicated dimensions.

At 606, the user places the generated paper (e.g., cut to the dimensions indicated by the paper size guide) flush against the raised ruler 114 and the box width stop 116, and the user engages the punch 108. In some arrangements, the arm extension 112 may be engaged to provide punch support for a paper size with greater dimensions.

At 608, the user scores the paper with the scoring stylus 110. The user scores three lines with the scoring stylus 110. The first line corresponds to the horizontal scoring guide 122 attached to the punch 108. The second line corresponds to the vertical scoring guide 124 attached to the punch 108. The third score line corresponds to the diagonal score guide 118 that is communicably coupled to the box height slider 104. In some arrangements, the arm extension 112 may be engaged to provide a longer horizontal scoring track for a paper size with greater horizontal dimensions.

At 610, the user repeats processes 606 and 608 to the remaining three sides of the paper. This includes rotating the paper ninety-degrees, ensuring the paper is flush against the raised ruler 114 and box width stop 116, and scoring the three lines with the scoring stylus 110. Upon completion of process 610, each side of the paper has a single notch and three lines scored.

At 612, the user flips the paper over and punches each side of the paper. This includes the user aligning the paper flush against the raised ruler 114 and the box width stop 116. Upon completion of process 612, each side of the paper now has two notches in addition to the three lines previously scored.

At 614, the user punches each corner of the paper. This includes placing the corner of the paper into the punch 108 and engaging in the punch 108 for all four sides. In some arrangements, the punch 108 has a crevice opposite of the horizontal scoring guide 122 and the vertical scoring guide 124 for receiving the corners of the paper.

At 616, the user folds along the score lines and assembles the paper into the box. The box will have the dimensions that the user determined at process 602.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples). Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

It should further be noted that for purposes of this disclosure, the term “coupled” means the joining of two members directly or indirectly to one another. Such joining may be stationary in nature or moveable in nature and/or such joining may allow for the flow of fluids, electricity, electrical signals, or other types of signals or communication between the two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, unless otherwise noted, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed:

1. An apparatus configured to create a box, the box having a box width and a box height, wherein the apparatus comprises:
a body;
a first control slider movably connected to the body, the first control slider structured to move to a width position, the width position altering the box width;
a second control slider movably connected to the body, the second control slider structured to move to a height position, the height position altering the box height;
a third control slider movably connected to the body, the first control slider, and the second control slider, the third control slider responsive to the width position of the first control slider and the height position of the second control slider; and
a size value guide movably connected to the third control slider, the size value guide responsive to movement of the third control slider, the size value guide indicating a paper needed to create the box with the box width and box height.

2. The apparatus of claim 1, further comprising:
a punch connected to the body, the punch comprises a vertical guide and a horizontal guide for scoring the paper and the punch structured to create a plurality of notches on each side and corner of the paper;
a first paper stop connected to the first control slider, wherein the first paper stop provides guidance in scoring the paper; and
a second paper stop connected to the second control slider, wherein the second paper stop provides guidance in scoring the paper.

3. The apparatus of claim 2, wherein the punch has a punch diameter, the punch diameter being an offset of the punch midpoint to edge, and wherein the size value guide is calculated using an equation of:
\sqrt{2}×(box height+box width)+2×punch diameter.

4. The apparatus of claim 1, further comprising:
a plurality of divots on the first control slider, the plurality of divots representing increments that provide guidance for the box width.

5. The apparatus of claim 4, wherein the increments of the plurality of divots is one-quarter inch.

6. The apparatus of claim 1, further comprising:
a plurality of divots on the second control slider, the plurality of divots representing increments that provide guidance for the box height.

7. The apparatus of claim 6, wherein the increments of the plurality of divots is one-quarter inch.

8. The apparatus of claim 1, further comprising:
an arm extension movably connected to the body, the arm extension movable relative to the body between a first position and a second position, wherein the second position allows for scoring the paper with a greater height than the arm extension in the first position.

9. The apparatus of claim 1, wherein the first control slider is structured to move latitudinally to the width position, and the third control slider moves latitudinally in response to latitudinal movement of the first control slider.

10. The apparatus of claim 1, wherein the second control slider is structured to move longitudinally to the width position, and the third control slider moves longitudinally in response to longitudinal movement of the second control slider.

11. A method of generating a box with a box height and a box width, the method comprising:
adjusting a first control slider movably connected to a body, the first control slider structured to move to a width position, the width position altering the box width;
adjusting a second control slider, the second control slider movably connected to the body, the second control slider structured to move to a height position, the height position altering the box height; and
identifying a size value, the size value movably connected to a third control slider, the third control slider responsive to the width position of the first control slider and the height position of the second control slider, and the size value identifying a paper needed to create the box with the box width and box height.

12. The method of claim 11, further comprising:
identifying a punch diameter, the punch diameter being an offset of a punch midpoint to edge, and wherein the size value is determined by an equation, the equation comprising:
\sqrt{2}×(box height+box width)+2×punch diameter.

13. The method of claim 11, further comprising:
selecting a paper, the paper having the size of the size value, wherein the paper comprises:
a first side, a second side, a third side, and a fourth side associated with boundaries of the paper,
a first corner, a second corner, a third corner, and a fourth corner associated with boundaries of the paper, and
a front side,
and a back side;
aligning the paper with the first control slider;
scoring and punching the first, second, third, and fourth side of the front side of the paper, wherein scoring and punching the front side comprises:
aligning the first side to a paper stop associated with the first control slider;
punching the first side of the paper using a punch, the punch being affixed to the apparatus, wherein the punch includes a vertical guide and a horizontal guide;
scoring on the first side a first line, a second line, and a third line, wherein the first line is associated with the vertical guide, wherein the second line is associated with the horizontal guide, and wherein the third line associated a second paper stop, the second paper stop being affixed to the apparatus, and the second paper stop is associated with the second control slider; and
rotating the paper ninety degrees and repeating the alignment, punching, and scoring for the second, third, and forth side;
flipping the paper to the back side;
punching the first side, second side, third side, and fourth side with the punch; and
punching the first, second, third, and fourth corner with the punch.

14. An apparatus configured to create a box, the box having a box width and a box height, wherein the apparatus comprises:
a first control slider movably connected to a body, the first control slider structured to move to a width position, the width position altering the box width;
a second control slider movably connected to the body, the second control slider structured to move to a height position, the height position altering the box height;
a third control slider movably connected to the body, the first control slider, and the second control slider, the third control slider responsive to the width position of the first control slider and the height position of the second control slider;
a size value guide movably connected to the third control slider, the size value guide responsive to movement of the third control slider, the size value guide indicating a paper needed to create the box with the box width and box height;
a punch connected to the body, the punch comprises a vertical guide and a horizontal guide for scoring the paper and the punch structured to create a plurality of notches on each side and corner of the paper;
a first paper stop connected to the first control slider, wherein the first paper stop provides guidance in scoring the paper; and
a second paper stop connected to the second control slider, wherein the second paper stop provides guidance in scoring the paper.

15. The apparatus of claim 14, wherein the first control slider is structured to move latitudinally to the width position, and the third control slider moves latitudinally in response to latitudinal movement of the first control slider.

16. The apparatus of claim 14, wherein the second control slider is structured to move longitudinally to the width position, and the third control slider moves longitudinally in response to longitudinal movement of the second control slider.

17. The apparatus of claim 14, wherein the punch has a punch diameter, the punch diameter being an offset of the punch midpoint to edge, and wherein the size value guide is calculated using an equation of:
\sqrt{2}×(box height+box width)+2×punch diameter.

18. The apparatus of claim 14, further comprising:
an arm extension movably connected to the body, the arm extension movable relative to the body between a first position and a second position, wherein the second position allows for scoring the paper with a greater height than the arm extension in the first position.

19. The apparatus of claim 1, further comprising:
a plurality of divots on the first control slider, the plurality of divots representing increments that provide guidance for the box width.

20. The apparatus of claim 1, further comprising:
a plurality of divots on the second control slider, the plurality of divots representing increments that provide guidance for the box height.
